(19) United States
(12) Patent Application Publication
(10) Pub. No.: US 2012/0064313 A1
(43) Pub. Date: Mar. 15, 2012

(54) Composite Undergarment Fabric with Improved Water Management

(75) Inventors: Moshe Rock, Brookline, MA (US); Charles Haryslak, Marlborough, MA (US)

(73) Assignee: MMI-IPCO, LLC, Lawrence, MA (US)

(21) Appl. No.: 13/256,716

(22) PCT Filed: Mar. 30, 2010
(86) PCT No.: PCT/US10/29128

§ 371 Date: Nov. 22, 2011

Related U.S. Application Data
(60) Provisional application No. 61/165,739, filed on Apr. 1, 2009.

(51) Int. Cl. B32B 7/02

(52) U.S. Cl. 428/212

(57) ABSTRACT

A composite undergarment fabric has an inner side fabric layer of synthetic yarn and an outer side fabric layer of yarn selected from among moisture-absorbent hydrophilic yarn, synthetic yarn rendered hydrophilic, and combinations thereo inner surface of the inner side fabric layer having a non-continuous treatment of durable, water repellent chemical, and the outer side fabric layer being relatively more hydrophilic than the inner side fabric layer. The inner and outer side fabric layers may be formed concurrently by knitting a plaited construction. In another implementation, the composite undergarment fabric has a pseudo plaited construction of a body of hydrophilic material with an inner side surface having a non-continuous treatment of durable water repellent chemical.

### TECHNICAL FIELD

This disclosure relates to composite undergarment fabrics.

### BACKGROUND

In typical composite undergarment fabrics, water management controls movement of liquid sweat (or water) from the inner side layer or surface of a knit construction, i.e. facing the skin, to the outer side layer or surface, facing away from the skin. This water management may be achieved, e.g., by contrasting denier of the fibers (dpf), with the inner side layer having dpf that is relative more coarse, e.g. 0.3 to 2.5 dpf, than the dpf of the outer side layer, e.g. 0.01 to 1.5 dpf; by use of synthetic fibers that have been rendered hydrophilic, e.g. on both the inner side layer and the outer side layer or only on the outer side layer; by selection of fiber blend, e.g. having hydrophilic fiber, i.e. natural fiber or regenerated fibers, such as cotton, wool, bamboo, cellulosic rayon, etc. on the outer side layer, blended with synthetic fibers, such as polyester, nylon, acrylic, etc., or by use of 100% hydrophilic fibers on the outer side layer; and/or by forming the outer and inner side fabric layers by plaited construction, e.g. by plaited jersey, double knit, plaited terry sinker loop, warp knit, tricot, woven fabric or double weave.

Composite undergarment fabrics formed by plaited knit construction and having good water management are described, e.g., in Lumb et al. U.S. Pat. No. 5,312,667; Rock et al. U.S. Pat. No. 5,344,698; Rock et al. U.S. Pat. No. 6,194,332; Rock et al. U.S. Pat. No. 6,602,811; and Rock et al. U.S. Pat. No. 7,217,456.

### SUMMARY

According to one aspect of this disclosure, a composite undergarment fabric comprises an inner side fabric layer of synthetic yarn and an outer side fabric layer of yarn selected from the group consisting of: moisture-absorbent hydrophilic yarn, synthetic yarn rendered hydrophilic, and combinations thereof, an inner surface of the inner side fabric layer having a non-continuous treatment of durable, water repellent chemical, and the outer side fabric layer being relatively more hydrophilic than the inner side fabric layer.

Preferred embodiments of this aspect of the disclosure may include one or more of the following additional features. The inner side fabric layer and the outer side fabric layer are formed concurrently by knitting a plaited construction. The synthetic yarn of the inner side fabric layer is rendered hydrophilic. The inner side fabric layer has a raised surface, and the non-continuous treatment of durable, water repellent chemical is applied pre-raising or post-raising. The inner side fabric layer has a flat surface. The fabric has a circular knit construction selected from the group consisting of 2-end fleece, 3-end fleece, terry with regular plaiting, double terry, double needle raschel, plaited single jersey, double knit, and terry knit with reverse plaiting. The inner side fabric layer comprises yarn fibers having a denier of at least that of the yarns fibers of the outer side fabric layer. The yarn fibers of the inner side fabric layer have a denier between 0.3 and 5.0 and the yarn fibers of the outer side fabric layer have a denier between 0.03 and 2.5. The moisture-absorbent yarn is selected from the group consisting of cotton, rayon, and wool.

The synthetic yarn material of the inner side fabric layer is selected from the group consisting of polypropylene, polyester, acrylic, and nylon. The inner side layer and/or the outer side layer comprises flame retardant fabric. The flame retardant fabric comprises fibers selected from the group consisting of: m-aramid fibers, modacrylic F/R rayon fibers, other F/R fibers, and blends of F/R fibers with non F/R fibers. Each of the layers has an elastomeric yarn plaited therein. The outer side fabric layer comprises at least 3% by weight of the moisture-absorbent yarn.

According to another aspect of this disclosure, a composite undergarment fabric comprises an inner side fabric layer of synthetic yarn selected from the group consisting of polyester, acrylic, and nylon, the synthetic yarn of the inner side fabric layer being naturally, or having been rendered, hydrophilic, and an outer side fabric layer of material selected from the group consisting of: (a) moisture-absorbent hydrophilic yarn selected from the group consisting of cotton, rayon, and wool; (b) synthetic yarn that has been rendered hydrophilic and selected from the group consisting of polyester, polypropylene, acrylic, and nylon; and (c) combinations of: moisture-absorbent hydrophilic yarn selected from the group consisting of cotton, rayon, and wool; synthetic yarn that has been rendered hydrophilic and selected from the group consisting of polyester, polypropylene, acrylic, nylon, or synthetic; and neutral synthetic yarn material not rendered hydrophilic and blended with natural fibers; the outer side fabric layer being relatively more hydrophilic than the inner side fabric layer, and the inner side fabric layer and the outer side fabric layer being formed concurrently by knitting a plaited construction.

According to another aspect of this disclosure, a composite undergarment fabric comprises a pseudo plaited construction comprising a body of hydrophilic material or material rendered hydrophilic defining an inner side surface and an outer side surface, with the inner side surface, facing a wearer's skin, having a non-continuous treatment of durable water repellent chemical.

Preferred embodiments of both of these aspects of the disclosure may include one or more of the following additional features. The inner side surface has a raised surface, and the non-continuous treatment of durable, water repellent chemical is applied pre-raising, or post-raising, or the inner side surface has a flat surface. The fabric has a construction selected from the group consisting of: single jersey knit, plain woven, and plain tricot. The body comprises flame retardant fabric, preferably comprising fibers selected from the group consisting of: m-aramid fibers, modacrylic F/R rayon fibers, other F/R fibers, and blends of F/R fibers with non F/R fibers. The body has an elastomeric yarn plaited therein.

Preferred embodiments of each of these aspects of the disclosure may include one or more of the following additional features. One or both of the outer side surface and the inner side surface are treated by at least one of (a) blending the yarn with fibers having anti-microbial properties; or (b) applying a paste or coating having anti-microbial properties. The particles of refractory compound are embedded only within yarn fibers of the inner side surface, the inner side surface has an area enlarged by a raising process for creating air spaces to enhance insulation performance and for reducing contact of the inner side fabric layer upon a wearer's skin, and a substantial portion of the particles of the refractory compound are spaced from the surface of the skin, due to the raising process, to cause body heat reflected by the particles to travel through the trapped air space of the raised surface region for insulated warming of the wearer's skin. The refractory compound is selected from the group consisting of titanium carbide, zirconium carbide, and hafnium carbide.

The details of one or more implementations of this disclosure are set forth in the accompanying drawings and in the description below. Other features, objects, and advantages of the disclosure will be apparent from the description and drawings, and from the claims.

### DESCRIPTION OF DRAWINGS

FIG. 1 is a somewhat diagrammatic representation of a composite undergarment fabric of this disclosure, e.g., formed of plaited knit construction.

FIG. 2 is a somewhat diagrammatic representation of another composite undergarment fabric of this disclosure, e.g. formed of plaited knit construction, here with plaited terry sinker loops on the technical back of the fabric, i.e., the inner side layer.

FIGS. 3, 4 and 5 are similar views of the composite undergarment fabric of FIG. 2, showing a sequence during which a drop of liquid sweat or water facing the sinker loops is pulled into the fabric by one or more loops, and then moved by wicking into the jersey technical face, i.e. the outer side surface, while the loop fibers/yarns of the inner side surface remain dry.

FIG. 6 is a somewhat diagrammatic representation of another composite undergarment fabric of the disclosure, here a fabric having a velour, fleece, or cut loop finish, and a raised surface.

FIGS. 7 and 8 are somewhat diagrammatic representations of another composite undergarment fabric of this disclosure, here of plaited jersey or double knit construction, showing a sequence during which a drop of liquid sweat or water on the inner side surface at a neutral or wicking section of the inner side layer is wicked towards the outer side layer, while the inner side layer remains dry next to the skin.

FIG. 9 is a somewhat diagrammatic representation of another implementation of a composite undergarment fabric of this disclosure, e.g. formed of “pseudo” plaited construction.

FIGS. 10 and 10A and FIGS. 11 and 11A are somewhat diagrammatic representations of other composite undergarment fabrics of plaited knit construction of FIG. 1 in other implementations of this disclosure.

Like reference symbols in the various drawings indicate like elements.

### DETAILED DESCRIPTION

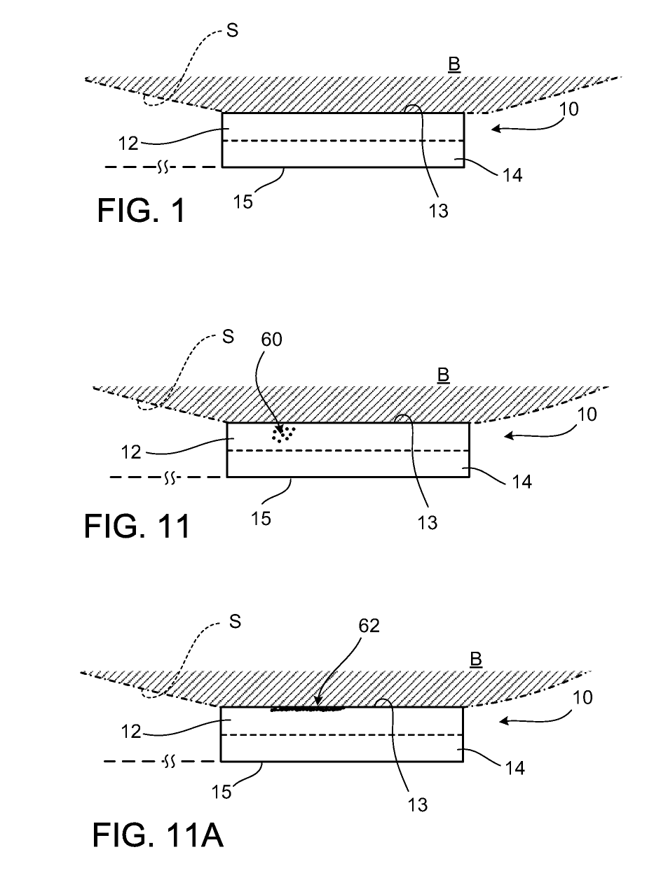

Referring to FIG. 1, a composite undergarment textile fabric 10 of this disclosure has a first or inner side fabric layer 12, being the layer closer to the wearer's body, B, made, e.g., of synthetic yarn, and a second or outer side fabric layer 14, being the layer further from the wearer's body, made, e.g., of yarn selected from the group consisting of moisture-absorbent (i.e., naturally hydrophilic) yarn, or synthetic yarn (e.g. rendered hydrophilic), and combinations thereof, the inner surface of the inner side fabric layer having a non-continuous treatment of durable, water repellent chemical. Both fabric layers 12, 14 are formed concurrently by knitting a plaited construction so that the layers are distinct and separate, yet integrated one with the other. As a result, the composite undergarment fabric functions as a single unit, e.g. for transport of moisture. The amount and proportion of each fabric layer is selected, based, e.g., on the desired weight of the composite fabric, the use of the composite fabric, and/or the specific requirements for transferring moisture from the inner side fabric layer to the outer side fabric layer. When the composite undergarment fabric 10 is worn, the inner side surface 13 of the inner side layer 12 is disposed generally in close proximity to or contact with the wearer's skin surface, S, and the outer side surface 15 of the outer side layer 14 faces away from the wearer.

The composite undergarment fabric may be warp knit or weft knit, including circular knits, such as: plaited jersey, double knit, plaited terry sinker loop, warp knit, tricot, woven fabric, double weave 2-end fleece, 3-end fleece, terry with regular plaiting, and double terry.

Significantly, the composite undergarment fabric 10 of this disclosure exhibits a differential in hydrophilicity from the inner side layer 12 to the outer side layer 14, preferably with the outer side layer 14 being relative more hydrophilic. For example, the outer side layer may be formed of fiber that is relatively more hydrophilic, or the fiber forming the outer side layer may be rendered relatively more hydrophilic. In one implementation, this relationship may be achieved by applying a suitable durable wicking agent to only the outer side layer 14, or the durable wicking agent may be applied both to the inner side layer 12 and to the outer side layer 14, but with relatively more of the durable wicking agent being applied to the outer side layer at a relatively higher o.w.f. (on-weight-fiber), as compared to the application of the durable wicking agent to the inner side layer. Examples of suitable durable wicking agent include: SUPRALEV 4470 (a low molecular weight polyester liquid-wicking compound, available from ABCO Industries (Roebuck, S.C.)); LUROTEX A-25 (a polyamide derivative hydrophilic finish, available from BASF); MILEASE T (a hydrophilic polymer for use as a durable textile finishing agent, available from Clariant (Muttenz, Switzerland)); and ASTRAPLUSH (a water-dispersible polyester, available from Bayer).

In another implementation of the disclosure, a non-continuous treatment of durable hydrophobic (i.e. water repellent) chemical agent, e.g. a chemical that suitably reduces the surface tension of the textile material, may be applied only to the inner side fabric layer 12, while only the outer side layer 14 is rendered hydrophilic. Suitable hydrophobic chemical agents may be based on, e.g., fluorocarbon, silicon, wax, etc., with or without extender or cross linking agent. The non-continuous treatment of durable hydrophobic chemical agent may be applied to the surface 13 of the inner side layer 12, e.g., by rotary screen print, gravure roll, spray or other suitable chemical application process. In another implementation, the hydrophobic chemical agent may be applied to the surface 13 of the inner side layer 12 of the composite undergarment fabric 10 after pretreatment of the outer side layer 14, or with pretreatment of both layers 12, 14, with a durable wicking agent. In both implementations, the hydrophobic chemical agent can be applied uniformly to the tips of the surface 13 of the inner side layer 12.

According to another implementation, the non-continuous treatment of durable hydrophobic chemical agent can be applied through a printing, e.g. screen printing, process, where the hydrophobic chemical agent is applied to selected fibers or regions of fibers at the surface 13 of the inner side layer 12, e.g., in a predetermined pattern. In this case, other fibers or regions of fiber at the surface 13 of the inner side layer 12 will remain without printing or application of the hydrophobic chemical agent. As a result, these fibers or regions of fibers without hydrophobic chemical agent will act to facilitate transfer of water or sweat from the surface 13 at the inner side layer 12, through to the outer side layer 14. In contrast, the fibers or regions of fibers that are printed with hydrophobic chemical agent, or to which hydrophobic chemical agent is otherwise applied, will remain, or quickly become, relatively dry next to the skin, S, even after being in touch with drops of liquid sweat or water, W.

As described in more detail below, other chemical additives or fibers, such as antimicrobial agents or refractory or ceramic particles, may be applied or incorporated into the composite undergarment fabric 10 prior to application of the hydrophobic chemical agent.

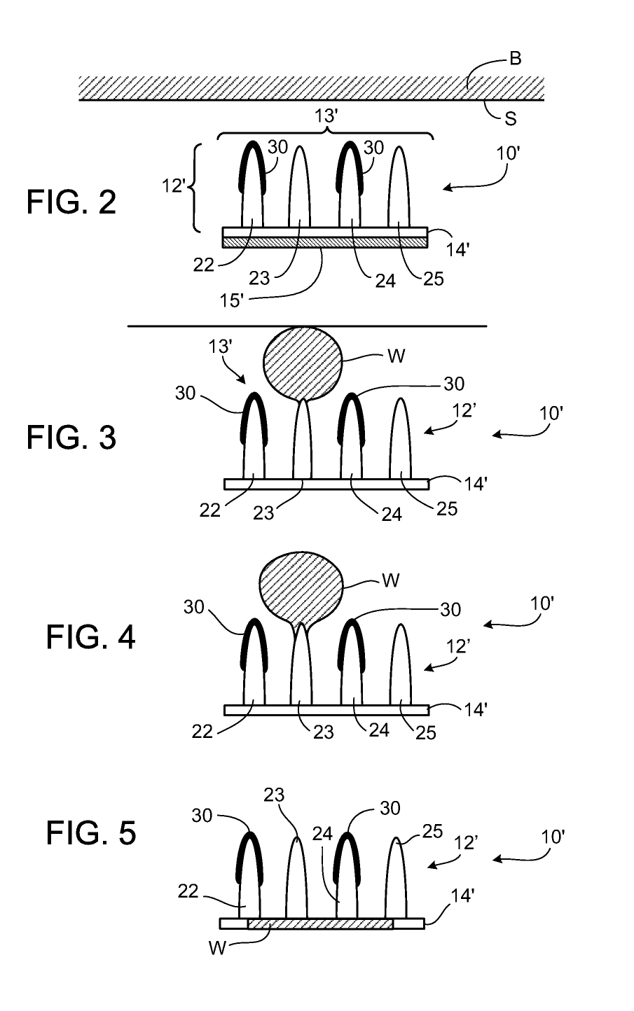

Referring now again to the drawings, by way of example, FIG. 2 shows a plaited terry sinker loop composite fabric 10′. The inner side layer 12′ has an inner surface 13′ (technical back) formed of loops 22, 23, 24, 25 facing the wearer's skin, S, while the outer side layer 14′ has a plaited jersey surface 15′ (technical face) facing away from the skin. As described above, a non-continuous treatment of durable hydrophobic (i.e. water repellent) chemical agent 30 is applied in a predetermined pattern, e.g. incorporating loops 22, 24, while loops 23, 25 are not treated with the hydrophobic chemical agent.

Referring now to FIGS. 3, 4 and 5, a drop of liquid sweat or water, W, facing the loops at the inner side surface 13′ (technical back) is pulled into the composite undergarment fabric by loop 23, which is neutral or treated with wicking agent prior to application of the hydrophobic chemical agent. The liquid water, W, is then moved by wicking into the jersey outer side layer 14′ (technical face), while the loop fiber/yarn of the inner side layer 12′ remains (or quickly becomes) dry, especially those fibers or regions, e.g. loops 22, 24, treated with hydrophobic chemical agent 30. In this manner, a drop of liquid sweat or water, W, facing the sinker loops 22, 23, 24, 25 of the inner surface 13′ is pulled into the fabric 10′ by one or more loops 23, 25 (which are neutral or treated with wicking agent), and then moved by wicking into the jersey technical face, i.e. the outer side surface 15′, while the loop fibers/yarns of the inner side surface remain dry.

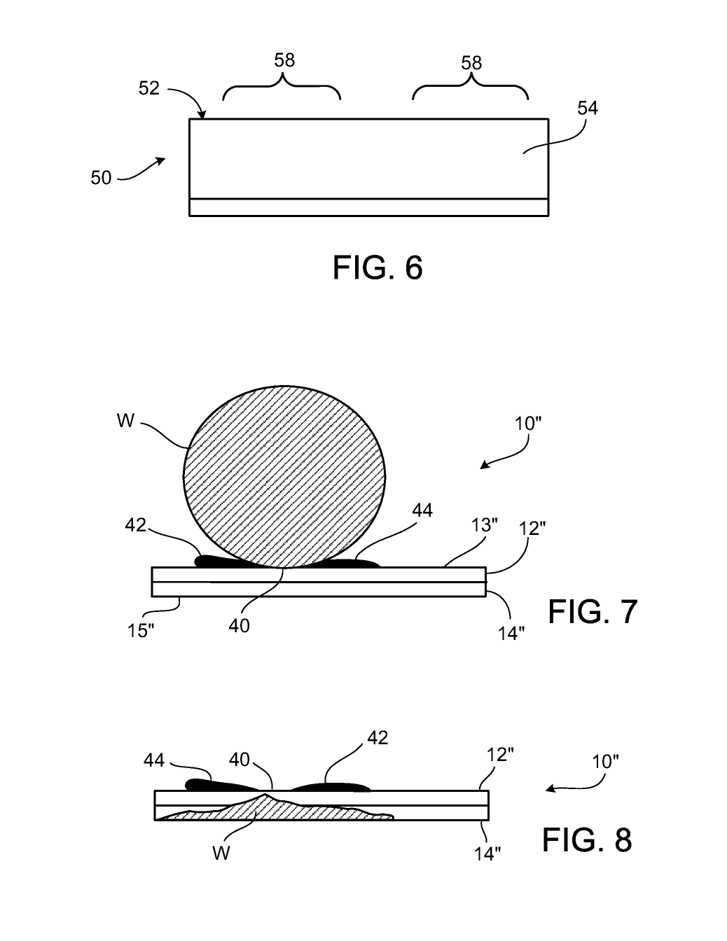

The inner surface of the inner side fabric, i.e. the surface worn facing the wearer, may be raised or flat. For example, referring to FIG. 6, in one implementation, in a raised surface fabric 50, the inner side fabric layer 52 comprises a raised surface region 54, with each fiber end being a conductor of moisture. The raised surface region 54 of the inner surface 56 of the inner side fabric layer 52 is achieved, e.g., by sanding, brushing or napping. Where the inner surface of the inner side fabric layer is to be raised, the non-continuous treatment of durable hydrophobic (i.e. water repellent) chemical 58 may be applied prior to (i.e. pre) raising, or the non-continuous treatment of durable hydrophobic (i.e. water repellent) chemical 58 may be applied after (i.e. post) raising.

Referring next to FIG. 7, in another implementation, a composite undergarment fabric 10″ of the disclosure is a plaited jersey or double knit, with hydrophobic chemical agent deposited in a pattern on the inner side surface 13″ of the inner side layer 12″. A drop of liquid sweat or water, W, rests on the surface in a neutral or wicking region 40, i.e. in a region without the non-continuous treatment of durable hydrophobic (i.e. water repellent) chemical agent 30, i.e., in contrast to adjacent regions 42, 44 that have been treated with the hydrophobic chemical agent.

Next, in FIG. 8, the water, W, is shown wicking towards the outer side layer 14″ through a neutral or wicking area 40, while the inner side layer 12″ remains (or quickly becomes) dry next to the skin surface of the wearer's body, especially in the region 42 treated with the non-continuous treatment of durable hydrophobic chemical agent. In this manner, a drop of liquid sweat or water, W, on the inner side surface 13″ at a neutral or wicking region 40 of the inner side layer 12″ is wicked towards the outer side layer 14″, while the inner side layer 12″ remains dry next to the skin, S. As described above, the water repellent or hydrophobic chemical agent of regions 42, 44 may be applied in a predetermined, non-continuous pattern, e.g. by printing or gravure roller, or in a random pattern, e.g. by spray.

The composite undergarment fabrics of this disclosure may also include other features and attributes selected to facilitate good water management. For example, referring again to FIG. 1, and also to FIGS. 2 through 8, the denier of the yarn fibers (as opposed to the denier of the yarn) of the inner side fabric layer 12 may be at least as great as, and preferably greater than, the denier of the yarn fibers of the outer side fabric layer 14. For example, the denier of the inner side fabric layer may be in the range of about 0.3 to 2.5 dpf, while denier of the outer side fabric layer may be in the range of bout 0.01 to 1.5 dpf. This differential serves to facilitate transport of liquid moisture that might otherwise collect at the skin surface, S, adjacent the inner side fabric layer 12, to the outer side fabric layer 14. When moisture collects at the first or inner side fabric layer, the quick transfer of moisture from the inner side layer to the outer side layer due to capillary action is facilitated, since the denier of the inner side layer yarn fibers is at least as great as, and preferably is greater than, the denier of the outer side layer yarn fibers, and, therefore, the inter-fiber space in the yarn of the inner side fabric layer is the same as or greater than that of the outer side fabric layer yarn.

Also, the denier of the yarn (as opposed to the denier of the yarn fibers) of the inner side fabric layer 12 is no greater than (but can be approximately the same as) the denier of the yarn of the outer side fabric layer 14. This provides for a greater liquid capacity in the outer side layer than in the inner side layer, which facilitates horizontal spreading of moisture along the surface 15 of the outer side fabric layer 14, i.e. moisture collected by the inner side fabric layer is transferred to the outer side fabric layer and more evenly distributed on the outer side fabric layer. Overall, moisture is more rapidly transported from the inner side fabric layer to the outer side fabric layer of the composite undergarment fabric, since there is a lesser build-up of moisture in specific fabric locations in the outer side fabric layer as a result of the facilitated spreading along the outer side fabric layer. Also, because the yarn of the outer side fabric layer is relatively more coarse than the yarn of the inner side fabric layer, the likelihood of a “sink effect” in the outer fabric layer is increased, and the likelihood of liquid moisture back-up into the inner side fabric layer, where it would wet the skin of the wearer, is reduced. The denier of the yarn of the outer fabric layer may be in a range, e.g., of between about 70 denier and 600 denier, while the denier of the yarn of the inner side fabric layer may be in a range, e.g., of between 30 denier and 300 denier.

The outer side layer 14, as described above, may be made entirely of synthetic yarn, or moisture absorbent (naturally hydrophilic) yarn, or it may be a blend thereof. It may also include elastomeric yarn plaited therein. If moisture absorbent yarn is included in combination with a synthetic yarn, the moisture-absorbent yarn may be present in an amount of at least 3% by weight, and preferably in an amount of at least 50% by weight, and the synthetic yarn material will have been rendered hydrophilic. The preferred moisture-absorbent yarn is cotton, as it can absorb 2 to 3 times its weight in water. Other suitable moisture-absorbent materials include rayon and wool, as well as other natural fibers. Alternatively, the second or outer side fabric layer may be made entirely from a synthetic yarn material, such as nylon, acrylic, polypropylene or polyester, which has been rendered hydrophilic.

The inner side fabric layer 12 includes either polyester, polypropylene, acrylic, or nylon material that is or has been rendered hydrophilic. It may also include an elastomeric yarn material plaited or commingled therein.

The inner side fabric layer 12 may utilize a fiber with a modified cross-section, or it may be chemically treated so that it is rendered hydrophilic, e.g., as described in Lumb et al. U.S. Pat. No. 5,312,667. If the outer side fabric layer 14 includes synthetic yarn that has been rendered hydrophilic, the denier per fiber may be smaller than the denier per fiber of the yarn in the first or inner side fabric layer. This may also be achieved as described in Lumb et al. U.S. Pat. No. 5,312,667.

The yarn of the outer side fabric layer 14 may be spun, multi-filament, textured, end-in-end, or any combination thereof.

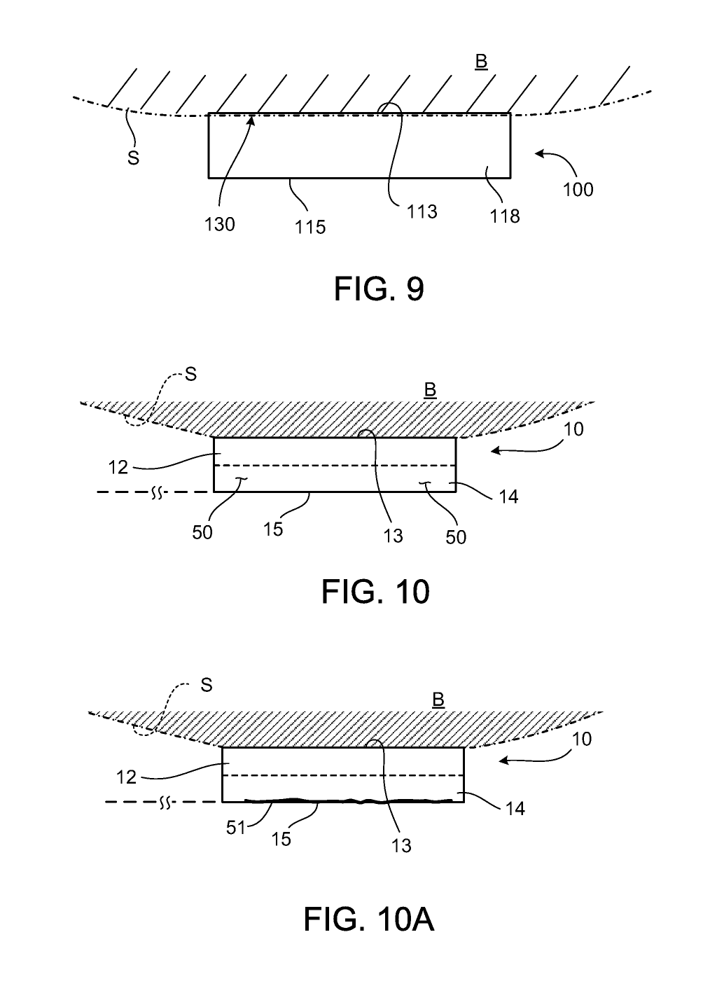

Referring next to FIG. 9, in other implementations of the disclosure, the composite undergarment fabric 100 is a non-plaited construction, e.g. single jersey knit or plain woven or plain tricot, which may be neutral, or which may be treated with wicking agent, or which may be formed of absorbent fiber, e.g. cotton, wool, viscous, etc., or which may be formed with synthetic fibers, or formed with a blend of absorbent fibers and synthetic fibers. The composite undergarment fabric has a body 118 defining an inner side surface 113, facing a wearer's skin, S, and an outer side surface 115. The inner side surface 113 is subjected to a non-continuous treatment of a durable water repellent chemical 130, e.g. as described above with respect to FIGS. 7 and 8, to generate a “pseudo” plaited construction.

The composite undergarment fabrics of disclosure may also be made of or include flame retardant fibers, such a m-aramid, modacrylic F/R rayon, etc., and blends with non F/R fibers.

Referring next to FIG. 10, in another implementation of the composite undergarment fabric of this disclosure, e.g., the fabric 10 described above with respect to FIG. 1, fibers 50 treated to have anti-microbial properties may be blended exclusively in the yarn of the outer side fabric layer 14. These treated fibers 50 may be selected from nylon or other man-made fibers with silver, copper or zinc metal (or ions of any thereof) physically or chemically bonded thereon or therein. Nylon that is physically or chemically bonded with ionic silver or copper is preferred and available in the marketplace. Nylon that has ionic silver or copper embedded within the fiber is also available in the marketplace. Whether the nylon or other synthetic yarn is coated with ionic silver or copper, or has one of these substances embedded therein, the amount of this special fiber blended into the yarn of the outer side layer may be between about 0.5% and 50% by weight.

Testing of composite undergarment fabrics 10 in which the outer side fabric layer 14 has incorporated therein fibers 50, e.g. nylon or another synthetic yarn coated or imbedded with ionic silver or copper, demonstrates that bacterial proliferation in the outer side fabric layer 14 is substantially inhibited. As a result, an oily mixture of lipids and proteins that has been secreted and migrated with liquid sweat from the wearer's skin through the inner side layer 12, ultimately collecting in the outer side layer of the fabric 14, does not decompose, and the production of body odor is substantially prevented.

Thus, the composite undergarment fabric 10 of the disclosure, because there is nothing interposed between the inner side and outer side fabric layers 12, 14, rapidly moves moisture away from the skin, S, and through a garment made with the composite undergarment fabric 10, enhanced by the creation of a moisture concentration gradient. In addition, because the outer side fabric layer 14 incorporates fibers 50 with anti-microbial properties, bacterial growth in that layer is substantially inhibited, and therefore, body odor is materially prevented.

In an alternative of this implementation, shown in FIG. 10A, a paste or coating 51 having anti-microbial properties may be applied exclusively to the outer side layer 14 of the composite undergarment fabric 10. The paste or coating preferably includes at least one of particulate silver, copper, zinc, or ions of any thereof. These particles are incorporated into the coating or paste 51 in an amount between about 0.01% and 50% by volume. Such pastes or coatings are readily available in the marketplace. The amount of the coating or paste 51 applied to the outer side layer 14 of the fabric 10 is between about 0.01% and 75% o.w.f. (on-weight-fabric).

The main component of the paste or coating 51, into which the particles are incorporated, may be polyurethane, acrylic, or silicone polymers. The paste or coating may be hydrophilic, such as by selecting polymers that are hydrophilic, or may be rendered hydrophilic by subsequent treatment. In order to improve fabric breathability, the paste or coating may be aerated (into a foam or froth) prior to application; it may also be applied to the outer side fabric layer 14 in a pattern or design having uncoated areas. In general, application of the paste or coating 51 to the outer side layer 14 of the fabric 10 is carried out with a roller, plain or rotogravure, a knife or by any other conventional coating technique. Application may also be carried out by screen printing. In other implementations of the disclosure, antimicrobial compound may be applied to both surfaces of the textile fabric, e.g. by pad, jet dyeing or other suitable process.

Referring next to FIG.11, in another alternative implementation of the composite undergarment fabric of this disclosure, e.g., the fabric 10 described above with respect to

FIG. 1, particles 60 of a refractory compound may be embedded into the fibers of the yarn forming the inner side fabric layer 12. This is achieved by either dispersing the particles in the master batch of polymer prior to spinning or by injecting the particles into the spinneret used for extruding the fibers from the polymer. These refractory particles 60 reflect low energy radiation of wavelengths greater than 2 μm. Since the human body radiates heat at wavelengths above 1 μm, peaking at 9 μm to 10 μm, use of yarn that incorporates refractory compounds promotes reflection of body heat by the inner side fabric layer 12 back to the body, B, of the fabric wearer, thereby reducing overall heat loss and enhancing insulation. In a raised surface fabric, the refractory compound particles reflect the radiated body heat through the air spaces inherent to such fabrics back to the body. Also, the inner side fabric layer 12 will absorb some of the near infrared radiation (less than 2 μm) emanating from the wearer's skin or from the ambient environment. The refractory compound may be selected, e.g., from Group IV transition metal compounds, such as carbides and oxides, including titanium carbide, zirconium carbide, hafnium carbide and zirconium oxide. The preferred refractory carbide compound is zirconium carbide. THERMOTRON® is a polyester yarn than contains zirconium carbide particles and may be obtained from Unitaka of Osaka, Japan.

Alternatively, as shown in FIG. 11A, the inner side fabric layer 12 of the composite undergarment fabric 10 of the disclosure may be treated by metal vapor deposition, a well known coating process. In accordance with the disclosure, a metal vapor deposit 62, utilizing aluminum, copper or some other metal, may be applied to the inner side fabric layer 12 by means of metal vapor deposition. Such treatment is most suitable where the composite undergarment fabric 10 is finished as a raised surface fabric, thereby effecting a reduction in conductive heat loss.

A number of implementations of the disclosure have been described. Nevertheless, it will be understood that various modifications may be made without departing from the spirit and scope of the disclosure. For example, the hydrophobic chemical agent may be applied to the surface 13 of the inner side fabric layer 12 in a random or other pattern. Also, a composite undergarment fabric of the disclosure may have both antimicrobial properties and particles of refractory compound for reflection of low energy radiation, as described above with respect to FIGS. 10, 10A and 11, 11A.

Accordingly, other implementations are within the scope of the following claims.

1. A composite undergarment fabric comprising an inner side fabric layer of synthetic yarn and an outer side fabric layer of yarn selected from the group consisting of: moisture-absorbent hydrophilic yarn, synthetic yarn rendered hydrophilic, and combinations thereof,
an inner surface of the inner side fabric layer having a non-continuous treatment of durable, water repellent chemical, and
the outer side fabric layer being relatively more hydrophilic than the inner side fabric layer.

2. The composite undergarment fabric of claim 1, wherein the inner side fabric layer and the outer side fabric layer are formed concurrently by knitting a plaited construction.

3. The composite undergarment fabric of claim 1, wherein the synthetic yarn is rendered hydrophilic.

4. The composite undergarment fabric of claim 1, wherein said inner side fabric layer has a raised surface, and said non-continuous treatment of durable, water repellent chemical is applied pre-raising.

5. The composite undergarment fabric of claim 1, wherein said inner side fabric layer has a raised surface, and said non-continuous treatment of durable, water repellent chemical is applied post-raising.

6. The composite undergarment fabric of claim 1, wherein said inner side fabric layer has a flat surface.

7. The composite undergarment fabric of claim 1, wherein the fabric has circular knit construction selected from the group consisting of 2-end fleece, 3-end fleece, terry with regular plaiting, double terry, double needle raschel, double knit, plaited jersey, and terry with reverse plaiting.

8. The composite undergarment fabric of claim 1, wherein the inner side fabric layer comprises yarn fibers having a denier of at least that of the yarns fibers of the outer side fabric layer.

9. The composite undergarment fabric of claim 8, wherein the yarn fibers of the inner side fabric layer have a denier between 0.3 and 5.0 and the yarn fibers of the outer side fabric layer have a denier between 0.03 and 2.5.

10. The composite undergarment fabric of claim 1, wherein said moisture-absorbent yarn is selected from the group consisting of cotton, rayon, and wool.

11. The composite undergarment fabric of claim 1, wherein said synthetic yarn material of said inner side fabric layer is selected from the group consisting of polypropylene, polyester, acrylic, and nylon.

12. The composite undergarment fabric of claim 1, wherein said inner side layer and/or said outer side layer comprises flame retardant fabric.

13. The composite undergarment fabric of claim 12, wherein the flame retardant fabric comprises fibers selected from the group consisting of: m-aramid fibers, modacrylic F/R rayon fibers, other F/R fibers, and blends of F/R fibers with non F/R fibers.

14. The composite undergarment fabric of claim 1, wherein each said layer has an elastomeric yarn plaited therein.

15. The composite undergarment fabric of claim 1, wherein said outer side fabric layer comprises at least 3% by weight of said moisture-absorbent yarn.

16. A composite undergarment fabric comprising an inner side fabric layer of synthetic yarn selected from the group consisting of polyester, acrylic, and nylon, said synthetic yarn of said inner side fabric layer being naturally, or having been rendered, hydrophilic, and an outer side fabric layer of material selected from the group consisting of:
a. moisture-absorbent hydrophilic yarn material selected from the group consisting of cotton, rayon, and wool;
b. synthetic yarn material that has been rendered hydrophilic and selected from the group consisting of polyester, polypropylene, acrylic, and nylon; and
c. combinations of: moisture-absorbent hydrophilic yarn selected from the group consisting of cotton, rayon, and wool; synthetic yarn that has been rendered hydrophilic and selected from the group consisting of polyester, polypropylene, acrylic, nylon, or synthetic; and neutral synthetic yarn not rendered hydrophilic and blended with natural fibers;
the outer side fabric layer being relatively more hydrophilic than the inner side fabric layer, and
the inner side fabric layer and the outer side fabric layer being formed concurrently by knitting a plaited construction.

17. A composite undergarment fabric comprising a pseudo plaited construction comprising a body of hydrophilic material or material rendered hydrophilic defining an inner side surface and an outer side surface, with said inner side surface, facing a wearer's skin, having a non-continuous treatment of durable water repellent chemical.

18. The composite undergarment fabric of claim 17, wherein said inner side surface is a raised surface, and said non-continuous treatment of durable, water repellent chemical is applied pre-raising.

19. The composite undergarment fabric of claim 17, wherein said inner side surface is a raised surface, and said non-continuous treatment of durable, water repellent chemical is applied pre raising post-raising.

20. The composite undergarment fabric of claim 17, wherein said inner side surface is a flat surface.

21. The composite undergarment fabric of claim 17, wherein the fabric has a construction selected from the group consisting of: single jersey knit, plain woven, and plain tricot.

22. The composite undergarment fabric of claim 17, wherein said body comprises flame retardant fabric.

23. The composite undergarment fabric of claim 19, wherein said flame retardant fabric comprises fibers selected from the group consisting of: m-aramid fibers, modacrylic F/R rayon fibers, other F/R fibers, and blends of F/R fibers with non F/R fibers.

24. The composite undergarment fabric of claim 17, said body has an elastomeric yarn plaited therein.

25. The composite undergarment fabric of claim 1 or claim 16 or claim 17, wherein one or both surfaces are treated by at least one of (a) blending the yarn with fibers having anti-microbial properties; or (b) applying a paste or coating having anti-microbial properties.

26. The composite undergarment fabric of claim 25, wherein particles of refractory compound are embedded only within yarn fibers of said inner side fabric layer,
said inner side surface has an area enlarged by a raising process for creating air spaces to enhance insulation performance and for reducing contact of the inner side surface upon a wearer's skin, and
a substantial portion of the particles of the refractory compound are spaced from the surface of the skin, due to the raising process, to cause body heat reflected by the particles to travel through the trapped air space of the raised surface region for insulated warming of the wearer's skin.

27. The composite undergarment fabric of claim 1 or claim 16 or claim 17, wherein particles of refractory compound are embedded only within yarn fibers of said inner side fabric layer;
said inner side surface has an area enlarged by a raising process for creating air spaces to enhance insulation performance and for reducing contact of the inner side surface upon a wearer's skin, and
a substantial portion of the particles of the refractory compound are spaced from the surface of the skin, due to the raising process, to cause body heat reflected by the particles to travel through the trapped air space of the raised surface region for insulated warming of the wearer's skin.

28. The composite undergarment fabric of claim 27, wherein said refractory compound is selected from the group consisting of titanium carbide, zirconium carbide, and hafnium carbide.
